(19) United States
(12) Patent Application Publication
(10) Pub. No.: US 2006/0078157 A1
(43) Pub. Date: Apr. 13, 2006

(54) Perceptible reversible watermarks

(75) Inventors: Alphons Antonius Maria Lambertus Bruekers, Eindhoven (NL); Minne Van Der Veen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/542,895

(22) PCT Filed: Dec. 16, 2003
(86) PCT No.: PCT/IB03/06153

§ 371 Date: Jul. 20, 2005

(30) Foreign Application Priority Data
Jan. 22, 2003 (EP) 03100127.4

(51) Int. Cl. G06K 9/00

(52) U.S. Cl. 382/100

(57) ABSTRACT

The invention relates to methods, devices and a signal, where an encoder compresses a first piece of information in the form of at least a first limited part of an image, provides perceptible additional information (38) related to the image, and provides the compressed first piece of information (40) in the image (36) and a decoder retrieves the image including the compressed first piece of information in the form of at least a first limited part of the image as well as the perceptible additional information, retrieves the perceptible additional information, and decompresses at least the compressed piece of information essentially without the losses for provision of at least one of image and perceptible additional information essentially without losses. The invention also relates to an image editor, a computer program product and a computer program element for processing additional information (38) such that the original image is restorable.

### TECHNICAL FIELD

The present invention generally relates to the field of providing perceptible additional information in relation to media content. The invention is more particularly related to providing perceptible reversible watermarks in signals comprising media content.

### DESCRIPTION OF RELATED ART

It is known to provide additional information in relation to media content. One such instance is within the field of watermarking, where information is hidden/embedded in the cover signal. As a consequence the information signal is hidden in a media file, like for instance an image. The watermark can then be retrieved from the image and used for different purposes, i.e. the watermark can be seen as an in-band channel in which information/data can be conveyed. The in-band channel has advantages in the sense that the information data is “tied” to the cover signal. i.e. it is not attached as headers.

One type of known watermarking is so called reversible watermarking. In literature this technique is also referred to as distortion-free watermarking or lossless watermarking. Reversible watermarking is a technique of watermarking (i.e. embedding data in a digital cover signal) in such a way that the original may be restored in the watermark detector/decoder. Strictly this method refers to a bit-exact reconstruction of the original cover signal, but a near-exact reconstruction may also fall in the category of reversible-watermarking techniques, i.e. that the difference between original cover and the reconstructed cover falls (i.e. the resulting distortion) is less than the distortion caused by the watermark. These reversibility principles are valid for any type of digital signal (e.g. images, video, audio, speech, etc.). An example of a reversible watermarking technique comprises compressing a bit-plane of an image, appending watermark to the compressed data and re-inserting the resulting bit-plane in the image. One such method is described in the article Distortion-free data embedding for images, by M. Goljan, J. Fridrich and R. Du, 2001, Information Hiding Workshop, Pittsburgh, USA.

This watermark is however hidden or almost not perceptible for a human in the above mentioned document, which makes it unsuitable for many different types of applications, that could otherwise benefit from the use of reversible watermarks. To the best of our knowledge there is in the document or in other literature nowhere described how reversible watermarking can be used for processing of additional information.

There is thus a need for the use of additional information relating to information content, which is relatively easily perceptible to a human user as well as for ways of processing watermarks inserted in media content in a way that allows restoring of the original media content.

### SUMMARY OF THE INVENTION

One object of the present invention is to provide the possibility to use perceptible additional information in a digital cover signal allowing processing and manipulation of both additional information and media content. Inserting logos (e.g. subtitle, station #) in a digital signal (audio, video, speech) in a traditional way “permanently” destroys the part of the signal, which is covered. We propose to embed these logos using reversible watermarking techniques. Moreover we propose a special editor/viewer for processing these data types.

According to a first aspect of the present invention, this object is achieved by a method of providing perceptible additional information in relation to a signal having media content, comprising the steps of:

compressing a first piece of information in the form of at least a first limited part of the media content essentially without losses, and providing the media content including at least the compressed first piece of

information together with perceptible additional information, such that the original media content and the additional information can be selectively presented to a user essentially without losses.

According to a second aspect of the present invention, this object is also achieved by a method of retrieving compressed information in a signal having media content comprising the steps of:

receiving or retrieving the media content including a compressed first piece of information in the form of at least a first limited part of the media content together with perceptible additional information,

retrieving the perceptible additional information from the media content, and presenting at least one of additional information and at least parts of the media content to said user essentially without losses.

According to a third aspect of the present invention this object is also achieved by a device for providing perceptible additional information in relation to a signal having media content, comprising:

an encoder arranged to:

compress a first piece of information in the form of at least a first limited part of the media content,

provide perceptible additional information related to the media content, and provide at least the compressed first piece of information in the media content, such that at least one of media content and perceptible additional information can be provided to a user essentially without losses.

According to a fourth aspect of the present invention this object is also achieved by a device for retrieving compressed information in a signal having media content, comprising:

a decoder, arranged to:

retrieve or receive the media content including a compressed first piece of information in the form of at least a first limited part of the media content as well as perceptible additional information,

retrieve perceptible additional information related to the media content, and

decompress at least one compressed piece of information essentially without losses for provision of at least one of media content and perceptible additional information to the user essentially without losses.

According to a fifth aspect of the present invention, this object is furthermore achieved by a signal comprising media content as well as additional information related to the media content, wherein the media content comprises a compressed first piece of information in the form of at least a first limited part of the media content such that the original media content and the additional information can be selectively presented to a user essentially without losses.

Claims 2 and 14 are directed towards methods where two pieces of the media content are compressed and provided together in order to provide the additional information in a location of the media content originally comprising a first of the pieces of media content.

Claims 3 and 15 are directed towards methods where a first limited piece of media content and the added information are compressed and provided together in the original location of the first piece of media content.

Another object of the present invention is to provide different means for allowing processing of added information provided in media content.

According to a sixth aspect of the present invention, this object is achieved by a media content editor comprising:

a decoder arranged to retrieve media content including a compressed first piece of information in the form of at least a first limited part of the media content together with additional information related to the media content,

an information presentation unit, and

a control unit allowing processing, under the control of a user, of the additional information, such that original media content is restorable in an essentially bit-exact manner.

According to a seventh aspect of the present invention, this object is also achieved by a computer program product and a computer program element, for editing of media content, to be used on a computer, comprising a computer readable medium having thereon:

computer program code means, to make the computer execute, when said program is loaded in the computer:

set a decoder to retrieve media content including a compressed first piece of information in the form of at least a first limited part of the media content together with additional information related to the media content, and

allow processing, under the control of a user, of the additional information, such that original media content is restorable in an essentially bit-exact manner.

The present invention has the advantage of providing embedding of perceptible additional information into media content and enables restoration of the original media content essentially without losses after removing the additional information. The invention also enables various forms of processing of additional information while allowing the possibility to recover original media content essentially without losses.

The general idea behind the invention is thus to provide perceptible additional information in media content while enabling essentially lossless recovery of the original media content. Another idea behind the invention is to provide functions for editing additional information that has been added to such essentially losslessly recoverable media content.

These and other aspects of the invention will be apparent from and elucidated with reference to the embodiments described hereinafter.

### BRIEF DESCRIPTION OF THE DRAWINGS

The present invention will now be explained in more detail in relation to the enclosed drawings, where

FIG. 1 shows a schematic drawing of a device according to the invention connected to another device via a network,

FIG. 2 shows a block schematic of the two devices connected to each other via the network,

FIG. 3 shows a block schematic of an image editor according to the invention,

FIG. 4 schematically shows a signal according to a first embodiment of the invention,

FIG. 5 schematically shows a signal according to a second embodiment of the invention,

FIG. 6 shows an image processed according to a method according to the first embodiment of the invention,

FIG. 7 shows a flow chart of a method of processing an image according to the first embodiment of the invention,

FIG. 8 shows a flow chart of a method of extracting information from an image processed according to the first embodiment of the invention, and

FIG. 9 schematically shows a computer program product according to the invention in the form of a CD ROM disc.

### DETAILED DESCRIPTION OF EMBODIMENTS

The present invention relates to the field of providing perceptible additional information in relation to a signal comprising media content. One preferred area of use is the area of reversible watermarking of image files. The invention is however not limited to this area, but can be used in many other different fields of technology, which will be described in more detail later on.

FIG. 1 schematically shows two computers 12 and 14 communicating with each other via a network 10 in the form of a computer network, which may be the Internet or an intranet. In an example of the invention the first device 12 is transmitting a signal comprising media content in the form of an image to the second device 14 over the network 10. It should be realized that FIG. 1 is only a simplified schematic drawing for showing the environment in which the invention can be provided. There could be several devices to which media content could be transmitted.

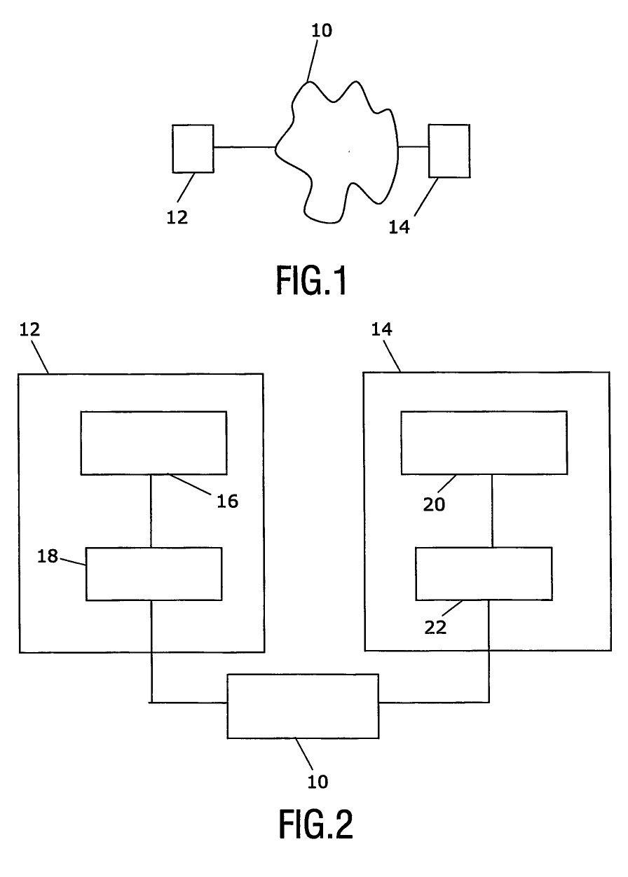

FIG. 2 shows a block schematic of the two devices interconnected via a medium 10, which is the Internet. The first device 12 includes an encoder 16, where the media is coded and a sender 18 sending the coded media content in a signal over the medium 10. The second device 14 includes a receiver 22 receiving a signal including the media content according to the invention and a decoder 20 for decoding the media content. It should be realized that FIG. 2 is greatly simplified in order to better show the invention. In reality both the first and second device could for instance include encoders, decoders, senders and receivers. The encoder 16 is furthermore arranged to perform normal image generation in addition to performing additional encoding according to the invention. In the same manner the decoder is arranged to perform ordinary image decoding as well as performing additional encoding according to the invention. Image files can be such files as TIF files. The invention will in the following be described in relation to a presently considered preferred embodiment using MRI (magnetic resonance imaging) images.

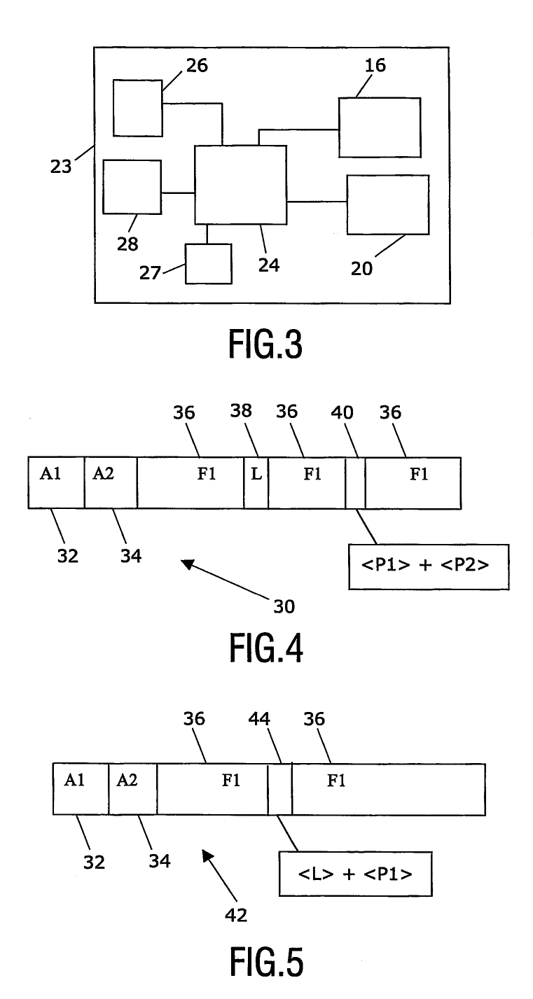

FIG. 3 shows a block schematic of a media content editor in the form of an image editor 23 according to the invention. The image editor 23 includes a control unit 24 to which an information presentation unit in the form of a display 26 is connected. The editor also includes a user input unit 28 in the form of a keyboard, an image store 27 as well as the previously described encoder 16 and decoder 20 all connected to the control unit 24. The device can also include senders and receivers for transmitting images according to the invention, although this is not necessary for all applications of the image editor.

FIG. 4 schematically shows a first embodiment of a signal format 30 for transferring an image according to the invention, where a first address field 32 includes the destination address A1 and a second address field includes a source address A2. These addresses are used for sending the signal from the first device to the second device. Thereafter there is a payload including an image 36, F1, into which there has been provided first additional information 38, L, and a second field 40 of compressed information.

FIG. 5 schematically shows a second embodiment of a signal 42 including coded media content F1, 36, according to the invention. Here there is a first and second address field 32 and 34 as well as the media content in the form of the image F1, 36. In the image F1 there is provided an embedded field 44. The functioning of this field will be described in more detail later on.

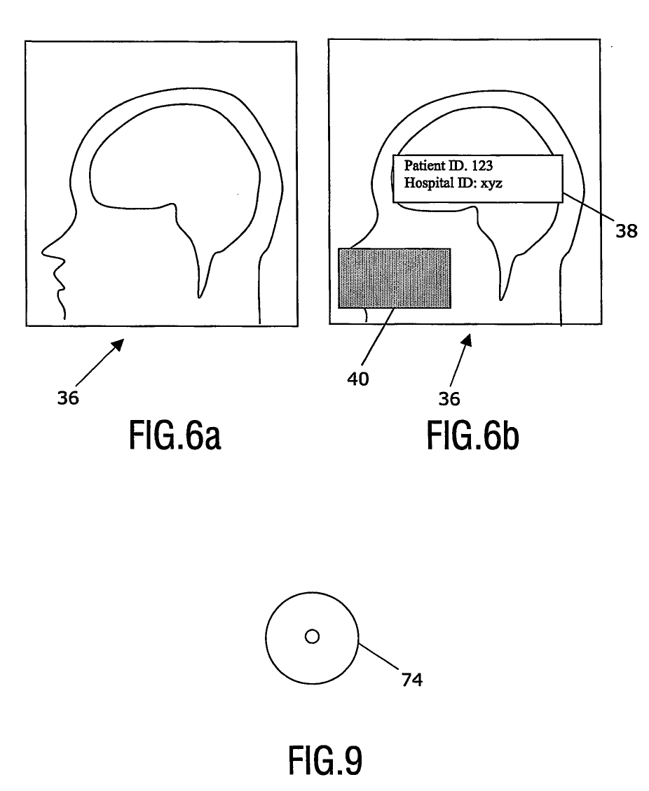

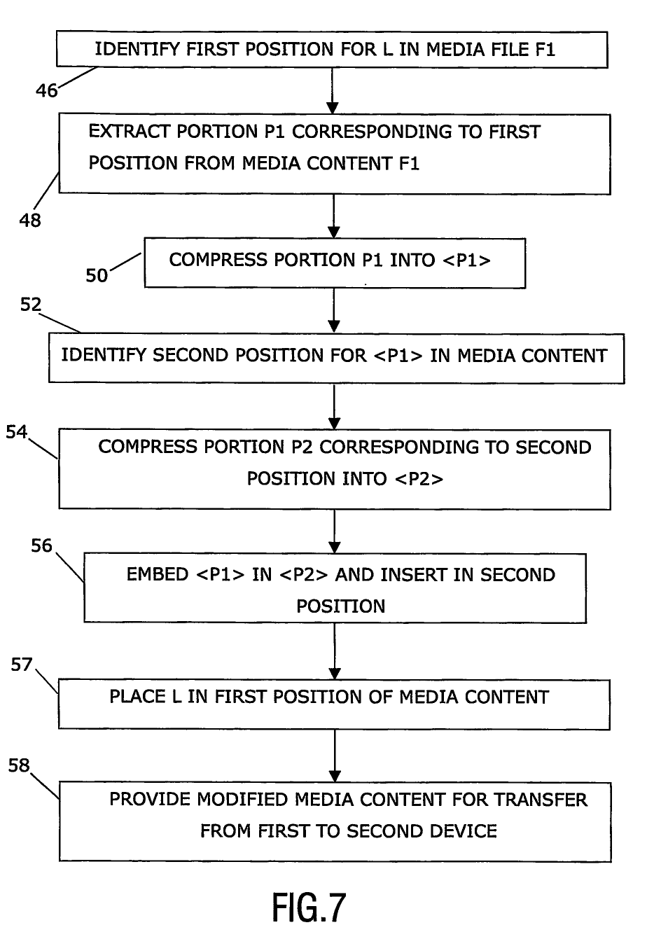

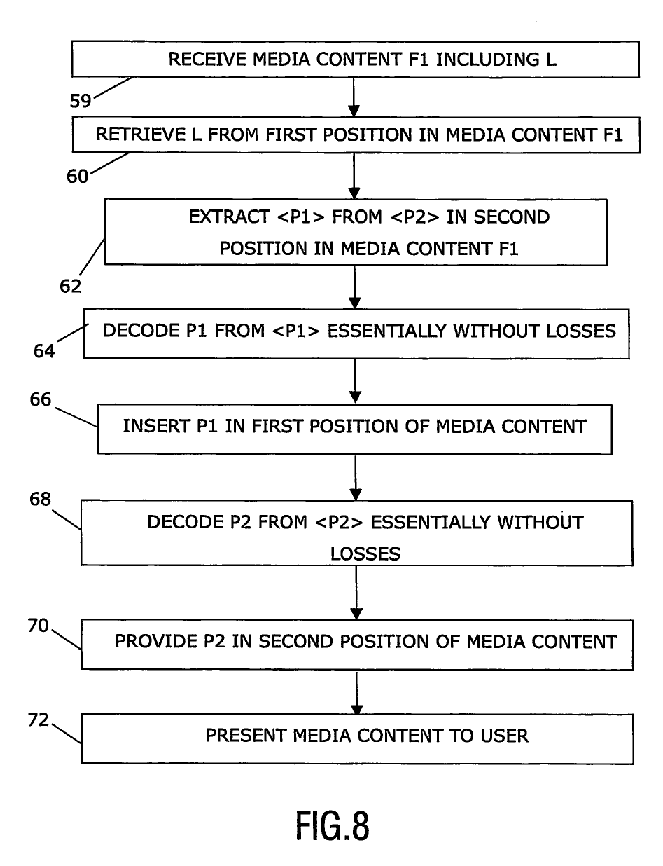

FIG. 6a shows an image 36 without additional information and FIG. 6b shows an image 36 with the added additional information 38 and further information 40. FIG. 7 shows a flow chart of a method of encoding an image according to a first embodiment of the invention, while FIG. 8 shows a flow chart of a method of decoding an image according to the first embodiment of the invention.

A first aspect of the present invention directed towards the coding of an image will now be described with reference to FIGS. 2, 4, 6 and 7. Media content in the form of an image F1, 36 is decided to be coded with additional information in the form of hospital data record in the first device 12. This means that perceptible additional data is decided to be added to the image. The additional data includes information regarding which patient the image concerns as well as information identifying the hospital, which is treating the patient. The coder 16 in question identifies a first position in the image 36 for inserting the additional information L, step 46. This can be somewhere that is easily visible or somewhere where the data in the image is disturbed the least. A first piece of information or the part of the image P1 where the additional information is to be inserted is then extracted, step 48, and this extracted portion p1 is then coded or compressed into a portion <p1>. Thereafter a second piece of information or second portion p2 where the compressed portion <p1> is to be inserted is identified, step 52. This portion p2 is then compressed into <p2>, step 54. Reversible watermarking is applied onto these compressed portions such that the first portion <p1> is embedded in the second compressed portion <p2> in an essentially lossless manner, step 56. The additional information L is then inserted in the media in the first position such that it can be seen, step 57. All these steps were performed in the coder 16. The image F1 with the added information and reversibly watermarked two portions is forwarded from the coder 16 to the sender 18. The image F1 including the additional information L and the compressed portions <p1> and <p2> are then transferred in signal 30 to the second device 14. In this way the image F1 with the additional information can be received in the second device 14.

The decoding of the file will now be described in relation to FIGS. 2, 4, 6 and 8. The second device 14 receives the signal 30 including the image F1 with inserted additional information L and compressed first and second portions <p1> and <p2> in the receiver 22, step 59, from where the image is forwarded to the decoder 20, which retrieves the added information L form the image 36, step 60. The decoder 20 then extracts <p1> from <p2> in the second position in the image F1 by reversible watermarking, step 62. This step is followed by decoding or decompressing of p1 from <p1> essentially without losses, step 64. The decoded or decompressed portion p1 is then inserted in the first position where the additional information L was previously placed, step 66, followed by decoding or decompressing of the second portion p2, which is then provided in the second position of the image, step 70. Thereafter the original image is presented to a user, step 72. In this way the original image has been retrieved such that analysis can be made of the whole image. It should be noted that just some of the steps of this method might be used depending on what information is needed. Later on in the description other ways of manipulating the coded image will be described. Also here it is important that the decoding is made in an essentially bit-exact manner.

A second embodiment of the coding according to the invention will now be described in relation to FIG. 5. FIG. 5 shows an image 42 in which the same additional information L has been inserted. The difference here is that instead of combining two compressed portions and placing them in a second position, the additional information L is compressed and combined with a compressed first portion <p1> of the image F1. The compressed portion <p1> and compressed additional information <L> is then inserted in the same position in the media file. Here the decoding principle is also working in a reversible manner in that first the additional information L is decoded from the first portion p1 and decompressed essentially without losses in order to be used. Then the first portion is decompressed essentially without losses and restored in the first position of the image.

There are many additional variations that can be made to this coding principle. A certain position of the image corresponding to a number of pixels need not be coded, instead the coding can be applied to for instance a certain bit plane of the original image. The invention is furthermore not limited to medical images, but other types of images are also feasible, where the additional information provided can be other types of information such as the logotype of a company. The additional information can be provided as a file of one type and the image as a file of the same or a different type. The additional information can furthermore be a hyperlink or another form of metadata tag, which can be used to link to a site on the Internet or an intranet. This site may also include cryptographic keys to be used for decoding the image.

It is furthermore possible to insert more than one piece of additional information, like another logotype in the image file in disjoint portions or into overlapping section of the same image. If two pieces of additional information are made to overlap, the order of coding and decoding is important. If a first additional piece of information L1 and a corresponding piece of information P1′ is encoded followed by a the coding of an additional piece of information L2 and the corresponding piece of information P1″ is coded afterwards, where P1′ corresponds to the portion of the image file where L1 is to be inserted and P1″ corresponds to the portion of the image file where L2 is to be inserted, the decoding has to take place in a reversible order, i.e. L2 and P1″ has to be decoded before L1 and P1′.

It is furthermore possible to use encryption of the first and second portions of the image when being placed together in the same spot or of the first portion and additional information when being compressed and placed together in the same spot in the image. In this case the code for the two added compressed pieces of information is scrambled upon coding and decoding would then need an original cryptographic key in order to be decrypted.

The additional information added to an image may furthermore be a noisy pattern from types of patterns used in visual cryptography. This noisy pattern may then be used for authentication-type purposes and be removed by a suitable decoding process.

The media content does furthermore not have to be an image, but can for instance be audio including audio or speech mastered with a voice-over indicating the owner of the audio. Here the voice-over can be removed in order to listen to the original audio. This voice-over may also be a trial version of the audio. The signal may also include video, in which case additional information like a logotype can be inserted in the video signal, the video sequence might then be possible to use by other users who can remove the added information and replace it with original information. It is furthermore possible that the media content in the signal is provided as a media stream, which has been coded with additional information.

The additional information and the coded portion of the image need furthermore not be provided in the same image, but can be provided in different images. For a coded video portion the additional information may be provided in a different part of the video than the coded video content, for instance in a different frame. There might furthermore be different types of signals when the invention is applied in a video environment. Then the additional information would perhaps be in the form of a logotype, maybe inserted in the video, while the compressed original information, taken from the position where the video is to be placed, may be embedded in the audio signal.

The encoder and decoder were in the passages above described as being provided in different devices communicating with each other via a network. It should be realized that the invention is in no way limited to this. The encoder and decoder could be provided in separate devices, where the transfer of media content from one device to the other could take place through a portable memory device, like a CD ROM disc. One device could also include both an encoder and a decoder according to the invention. Instead of being sent an image including additional information could then be stored in a memory by the encoder. The stored image could then be retrieved from the memory by the decoder.

Now a second aspect of the present invention will be described with reference to FIG. 3, showing the image editor 12 according to the invention. Images with or without additional information are stored in the image store 27. These images could have been received from another device via a receiver (not shown). A user of the image editor may then present an image with the additional information for presentation on the display 26. This means that when the additional information is provided in the media content, it is perceptible to the user. Selections of what is to be presented and how the images are to be processed is decided by the user through using the keyboard 28. When the user selects an image having additional information from the image store 27, it is then presented on the display 26 including the visible additional information. In case the image is a file coded like the file in FIG. 6, the additional information is presented on top of the image and the section of the image previously provided in the position where the additional information is provided is coded in a second portion of the image. If the user wants to see the whole image, the control unit 24 then sends the image to the decoder 20, which removes the additional information from the image and restores the original image in the way described above in relation to FIG. 8. The user can then select to store the additional information as a new image and also store the original image without the additional information. The removal can be done by the user using a cursor on the screen of the display, marking the additional information and dropping it outside the image. Here the user can also place the additional information in another position of the image. If he does this, the control unit 24 removes the additional information from the first position and restores the original image through the use of the decoder 20. When the user then selects a new position in the image where the additional information is to be placed, the control unit 24 connects to the coder 16, which removes the part of the image where the additional information is to be placed and codes it together with another part of the image file and thereafter inserts the additional information in the position of the first removed piece of information of the image file in the same way as was described earlier.

The user can also add a second piece of further information, in which case the control unit 24 connects to the coder 16, which inserts the additional information in the previously described manner. Coding and decoding in the image editor could of course also be made according to the second embodiment.

The editor can furthermore include another function and that is that when inserting a new piece of additional information or moving an existing piece of additional information, the control unit 24 can analyze the information in the image in order to find a portion of the image that causes the least perceptible distortion when displaying the image on the display. The control unit can furthermore be arranged to identify portions in the form of location and size, where additional information can be embedded. The additional information can furthermore be in the form of a hyper-link to a web page comprising yet further information in relation to an image, like for instance cryptographic keys. Then the control unit is arranged to set the decoder to extract at least parts of the additional information and use this for connection to said web page. The hyper-link can also be moved to another location in the image.

The image editor might furthermore have another function and that is that the additional information might include instructions on how to animate the image. The control unit then extracts this information and makes the image animated using these instructions.

Another variation is that the additional information added to the image would include interpolated values of the original samples of the pixel information. In this way the resolution of an image can easily be expanded and compressed as long as the position of the original samples are known.

Other possible variations are that the media content editor can of course in a similar manner be provided for other types of media like vide or audio, as has been described previously. There are also other types of information presentation devices possible than keyboards. One such a device is a speaker. In the same way there might be other types of user input units than keyboards. The additional information need furthermore not be perceptible to a user of the image editor, but can just as well be hidden.

The image editor is preferably provided in the form of at least one processor with corresponding program memory including program code for performing the functions of the editor. This program code can also be downloaded from another computer via the Internet or an intranet or be provided on a computer readable medium. FIG. 9 shows one such medium in the form of a CD ROM 74 on which this program code is stored. A computer having a coder and decoder will then perform the functions of the image editor, when this program code is being loaded into it. It should be realized that other types of computer readable mediums can also be used such as magnetic discs.

In the description the term coding and decoding have been used. This is intended to mean the providing of additional information in media content as well as the removal of such content and/or reading the additional information, i.e. the watermark, and/or restoring the original media content.

The present invention has many advantages, such as allowing a user to insert and send perceptible additional data in relation to image content and remove such additional data and restore the original image content in a lossless or essentially lossless manner. In this way the risk of losing additional data related to media content is diminished. It furthermore opens up for a variety of ways in which the additional data and the media content can be processed and manipulated. In the medical environment it could furthermore be possible for a doctor or other personnel in a hospital to use a lossless viewer. The user may then use his lossless viewer to drag-and-drop the logo to different positions in the image or to remove it temporarily. A further advantage would be to work on a “what you see is what you get” basis just like in ordinary drawing programs.

The invention can be summarized as follows. The invention relates to methods, devices and a signal, where an encoder compresses a first piece of information in the form of at least a first limited part of an image, provides perceptible additional information (38) related to the image, and provides the compressed first piece of information (40) in the image (36) and a decoder retrieves the image including the compressed first piece of information in the form of at least a first limited part of the image as well as the perceptible additional information, retrieves the perceptible additional information, and decompresses at least the compressed piece of information essentially without losses for provision of at least one of image and perceptible additional information essentially without losses. The invention also relates to an image editor, a computer program product and a computer program element for processing additional information (38) such that the original image is restorable.

1. Method of providing perceptible additional information (L) in relation to a signal (30; 42) having media content (F1) comprising the steps of:
compressing a first piece of information (P1) in the form of at least a first limited part of the media content essentially without losses, (step 50), and
providing the media content (F1) including at least the compressed first piece of information (<P1>) together with perceptible additional information (L), (step 58) such that the original media content and the additional information can be selectively presented to a user essentially without losses.

2. Method according to claim 1, further including the steps of:
compressing a second piece of information (P2), (step 54), and providing the compressed first and second pieces of information together in the media content, (step 56), such that the media content including the first and second pieces of information can be retrieved essentially without losses.

3. Method according to claim 2, wherein the second piece of information (P2) is in the form of a second limited part of the media content (F1) and the step of providing the first and second information in the media content comprises providing these pieces of information in the original position of the second piece of information within the media content, (step 56).

4. Method according to claim 1, wherein the additional information is provided in another section of the media content than at least the first compressed piece of information.

5. Method according to claim 1, wherein the additional information is provided in another signal than the first piece of compressed information.

6. Method according to claim 5, wherein the signal comprising the additional piece of information is of another type than the signal including the first piece of information.

7. Method according to claim 1, wherein the additional information is of the same type as the media content and is provided in the original position of the first piece of information of the media content, (step 57).

8. Method according to claim 2, wherein the second piece of information is the additional piece of information and the step of providing the first and second pieces of information in the media content comprises providing these pieces of information in the original position of the first piece of information within the media content.

9. Method according claim 1, wherein the media content comprises an image (F1).

10. Method according to claim 1, wherein the media content comprises video.

11. Method according to claim 1, wherein the media content comprises audio.

12. Method according to claim 1, wherein the additional information comprises a hyperlink.

13. Method of retrieving compressed information in a signal having media content comprising the steps of:
receiving or retrieving the media content (F1) including a compressed first piece of information in the form of at least a first limited part of the media content together with perceptible additional information (L), (step 59),
retrieving the perceptible additional information from the media content, (step 60), and
presenting at least one of additional information and at least parts of the media content to said user essentially without losses, (step 72).

14. Method according to claim 13, wherein the media content includes a compressed second piece of information which is also retrieved and further including the step of selectively decompressing, (step 64, 68) under the control of a user, at least one of the compressed pieces of information essentially without losses for provision to the user.

15. Method according to claim 14, wherein the first and second pieces of information are provided in the same location of the media content and further including the step of placing the first piece of decompressed information in the location of the compressed first and second pieces of information within the media content.

16. Method according to claim 14, wherein the first and second pieces of information are provided in the same location of the media content and further including the step of placing the second piece of decompressed information in the location of the compressed first and second pieces of information within the media content, step 70).

17. Device for providing perceptible additional information in relation to a signal (30; 42) having media content (F1) comprising:
an encoder (16) arranged to:
compress a first piece of information (P1) in the form of at least a first limited part of the media content,
provide perceptible additional information (L) related to the media content, and provide at least the compressed first piece of information in the media content, such that at least one of media content and perceptible additional information can be provided to a user essentially without losses.

18. Device for retrieving compressed information in a signal (30; 42) having media content (F1), comprising:
a decoder (20), arranged to:
retrieve or receive the media content including a compressed first piece (<P1>) of information in the form of at least a first limited part of the media content as well as perceptible additional information (L),
retrieve perceptible additional information related to the media content, and
decompress at least one compressed piece of information essentially without losses for provision of at least one of media content and perceptible additional information to the user essentially without losses.

19. Signal (30; 42) comprising media content (F1) as well as additional information (L) related to the media content, wherein the media content comprises a compressed (<P1>) first piece of information in the form of at least a first limited part of the media content such that the original media content and the additional information can be selectively presented to a user essentially without losses.

20. Media content editor (23) comprising:
a decoder (23) arranged to retrieve media content including a compressed first piece of information (<P1>) in the form of at least a first limited part of the media content together with additional information (L) related to the media content,
an information presentation unit (26), and
a control unit (24) allowing processing, under the control of a user, of the additional information, such that original media content is restorable in an essentially bit-exact manner.

21. Media content editor according to claim 20, wherein the control unit is arranged to make the information presentation unit present the additional information over at least a part of the original media content on the information presentation unit.

22. Media content editor according to claim 20, wherein the control, unit is arranged to read a hyper-link provided in the additional information and connect to a web page associated with the hyper-link.

23. Media content editor according to claim 20, wherein the control unit is arranged to provide further additional information over the original media content.

24. Media content editor according to claim 20, wherein the control unit is arranged to allow identification of areas in the original media content, which causes least perceptual distortion if additional information is provided over said area.

25. Media content editor according to claim 20, wherein the control unit allows the insertion of new interpolated values between original signal samples.

26. Computer program product (74), for editing of media content, to be used on a computer, comprising a computer readable medium having thereon:
computer program code means, to make the computer execute, when said program is loaded in the computer:
set a decoder to retrieve media content including a compressed first piece of information in the form of at least a first limited part of the media content together with additional information related to the media content, and
allow processing, under the control of a user, of the additional information, such that original media content is restorable in an essentially bit-exact manner.

27. Computer program element for editing of media content, to be used on a computer, said computer program element comprising:
computer program code means, to make the computer execute, when said program is loaded in the computer:
set a decoder to retrieve media content including a compressed first piece of information in the form of at least a first limited part of the media content together with additional information related to the media content, and
allow processing, under the control of a user, of the additional information such that original media content is restorable in an essentially bit-exact manner.
